(19) United States
(12) Patent Application Publication
(10) Pub. No.: US 2003/0094126 A1
(43) Pub. Date: May 22, 2003

(54) Portable accident marking system

(76) Inventor: Blair D. Wallhouse, Toronto (CA)

Correspondence Address: BLAIR WALLHOUSE, 343 MILLWOOD RD., TORONTO, ON, M45 1J9, CA

(21) Appl. No.: 10/284,823

(22) Filed: Nov. 1, 2002

(30) Foreign Application Priority Data
Nov. 21, 2001 (CA) 2 363 966

(51) Int. Cl. G01D 21/00

(52) U.S. Cl. 116/209

(57) ABSTRACT

This invention relates to a portable accident marking system used in conjunction with a snowboard (skis or the like), to alert others of an accident. Generally, accident marking systems consist of an apparatus that has to carried by rescue workers or sport enthusiasts. This apparatus usually incorporates rigid components that when carried are inconvenient and possibly dangerous and often necessitate time-consuming assembly. The system of the present invention is simple and has no rigid components and can be installed quickly and conveniently. This invention relates to a portable marking system for use in conjunction with a snowboard, skis or other rigid apparatus comprising: (a) at least one positioning means to be attached to an extremity of the apparatus, (b) a main attention attracting body attached to said positioning means, (c) a second means for securing said main body to a portion of the rigid apparatus remote from said first extremity.

### BACKGROUND OF THE INVENTION

Each year ski patrollers and other first responders at ski resorts have to deal with the after math of an accident. While tending to the primary incident, it is not uncommon to have other resort patrons ski or “slide” into the patent and medical personnel. This is commonly due to the accident not being clearly marked or the guest not recognizing the pending hazard. There exists a need for a PORTABLE ACCIDENT MARKING SYSTEM that can be utilized by fist responders to warn others of an accident or other potential hazards.

The Portable Accident Marking System needs to light weight, portable, pose no risk to the carrier and highly visible in all weather conditions. This is accomplished by using a “cloth” like material that is bright in colour and has reflective properties. It does not contain any rigid members and is completely collapsable.

### SUMMARY OF THE INVENTION

It is therefore a first advantage of the invention to address the shortcomings of the currently available accident marking systems by providing a safety apparatus that is compatible with available snow recreational equipment. This device is made of a pliable material that can easily fold and fit into a small pocket and does not pose a threat to the carrier if they fall. The device uses a snowboard (skis or the like) as the frame work to give the unit structure unlike other available accident markers which have integral unremovable rigid members that are of metal or hard plastic. The marker is easily and quickly applied and does not require time consuming setup nor does it pose a fire hazard.

It is a second advantage of the invention to provide the user with a brightly coloured material that may or may not have reflective properties and is highly visible in all weather conditions. It could contain writing or other symbols to aide in its effectiveness.

It is a third advantage of the invention to provide a marker that can be setup using the carriers snowboard (skis or the like). This enables the device to be deployed any where on a hill and be adjusted to provide maximum visibility to those who are approaching.

### BRIEF DESCRIPTION OF THE DRAWINGS

The aforementioned advantages of the invention as well as additional advatanges therof will be more clearly understood hereinafter as a result of a detailed description of a preferred embodiment of the invention when taken in conjunction with the following drawings in which:

FIG. 1. Is an overall view of the invention.

FIG. 2. Is an exploded view of the “Main Body” marked as (1)

FIG. 3. Is an exploded view of the “End Caps” marked as (4)

FIG. 4. Is an exploded view of the “Centre” grommet and other components marked as (5)

FIG. 5. Is an exploded view of the “Corner” grommets marked as (2)

FIG. 6. Is an exploded view of an alternative method of construction of the “End Caps” marked as (4)

FIG. 7. Is an exploded view of an alternative method of construction of the “Main Body” marked as (1)

### SPECIFICATION OR DETAILED DESCRIPTION OF THE INVENTION

This invention relates to a portable accident marking system used in conjunction with a snowboard (skis or the like), to alert others to an accident. Generally, accident marking systems consist of an apparatus that has to carried by rescue workers or sport enthusiasts. This apparatus usually incorporates rigid components that when carried are inconvenient and possibly dangerous and often necessitate time-consuming assembly. The system of the present invention is simple and has no rigid components and can be installed quickly and conveniently. This invention relates to a portable marking system for use in conjunction with a snowboard, skis or other rigid apparatus comprising: (a) at least one positioning means to be attached to an extremity of the apparatus, (b) a main attention attracting body attached to said positioning means, (c) a second means for securing said main body to a portion of the rigid apparatus remote from said first extremity.

A preferred embodiment of this invention is described as follows.

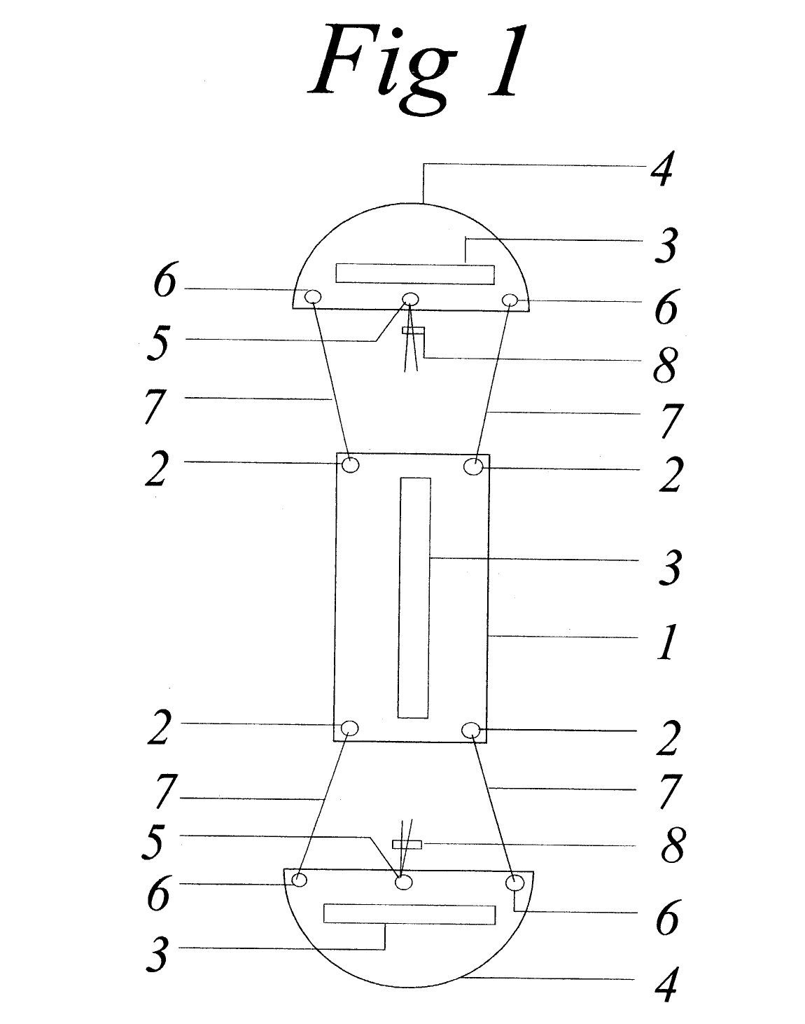

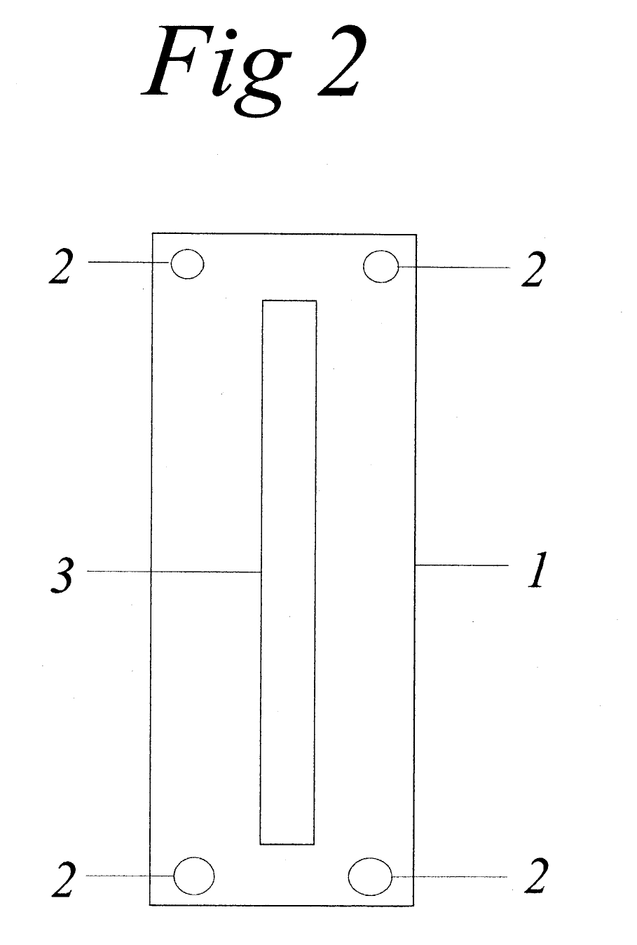

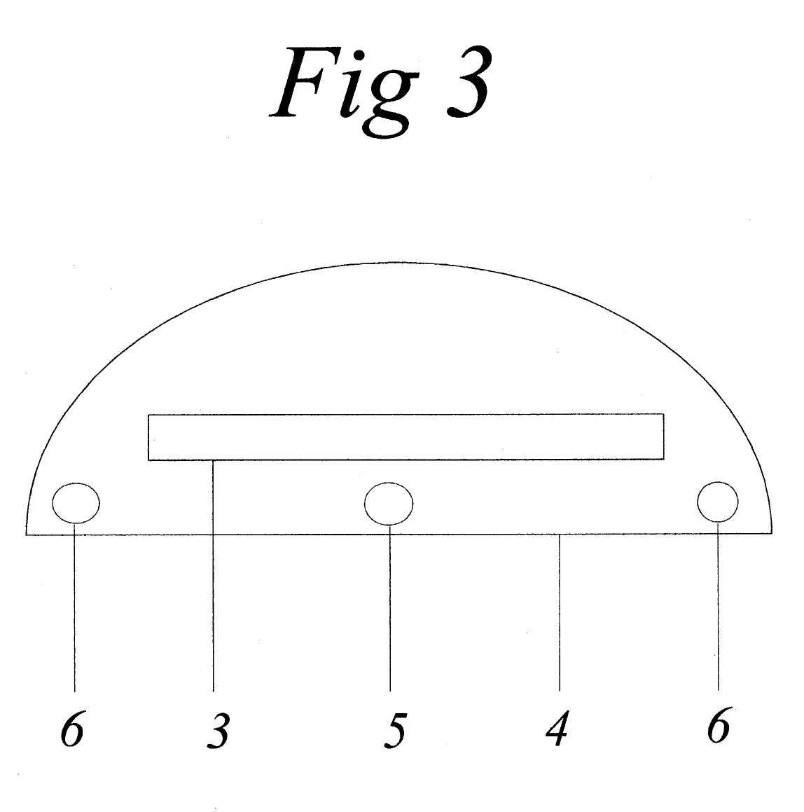

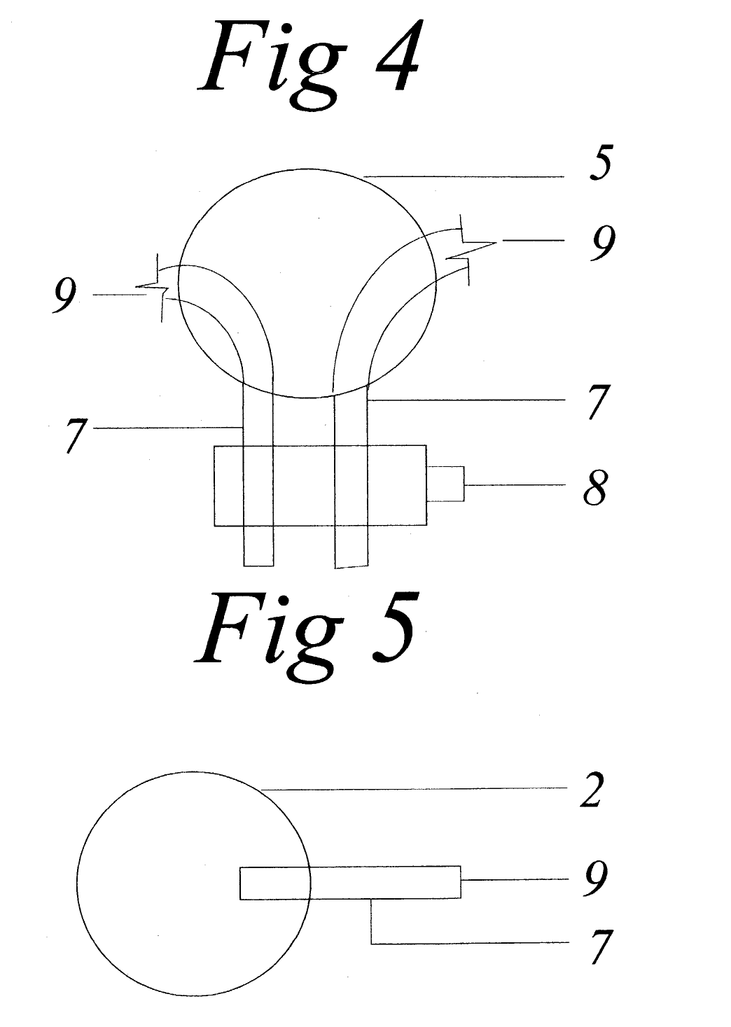

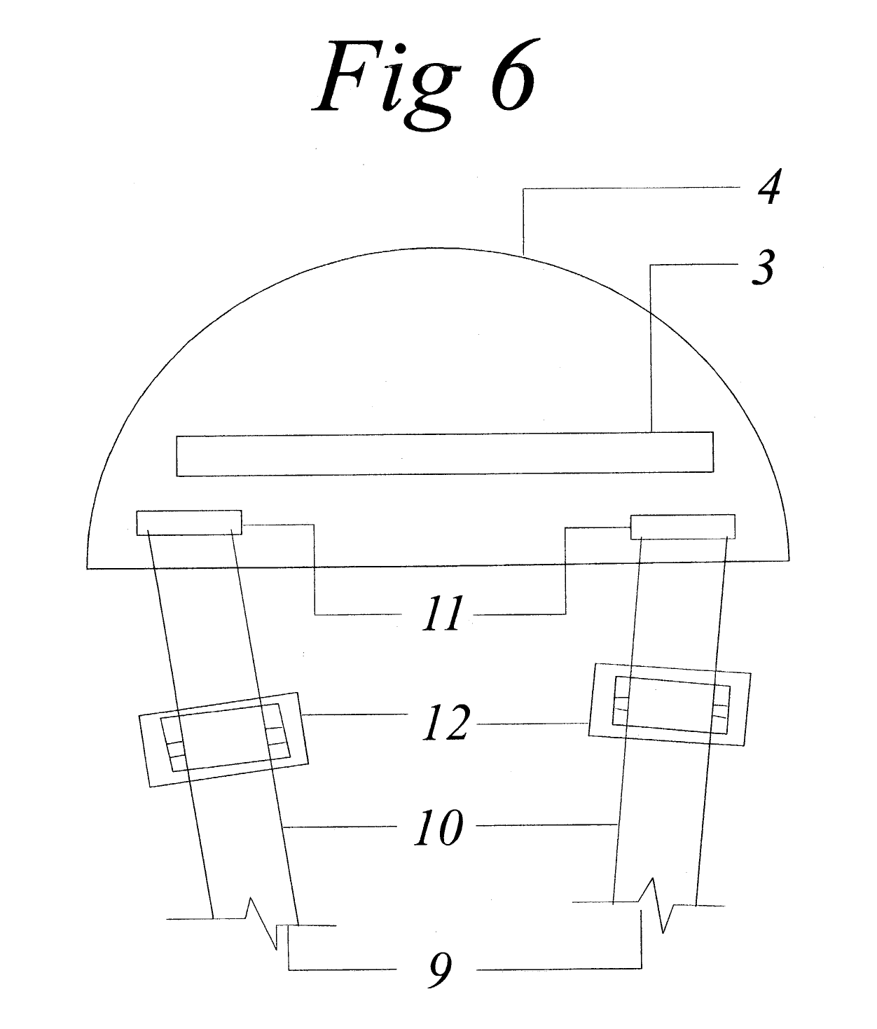

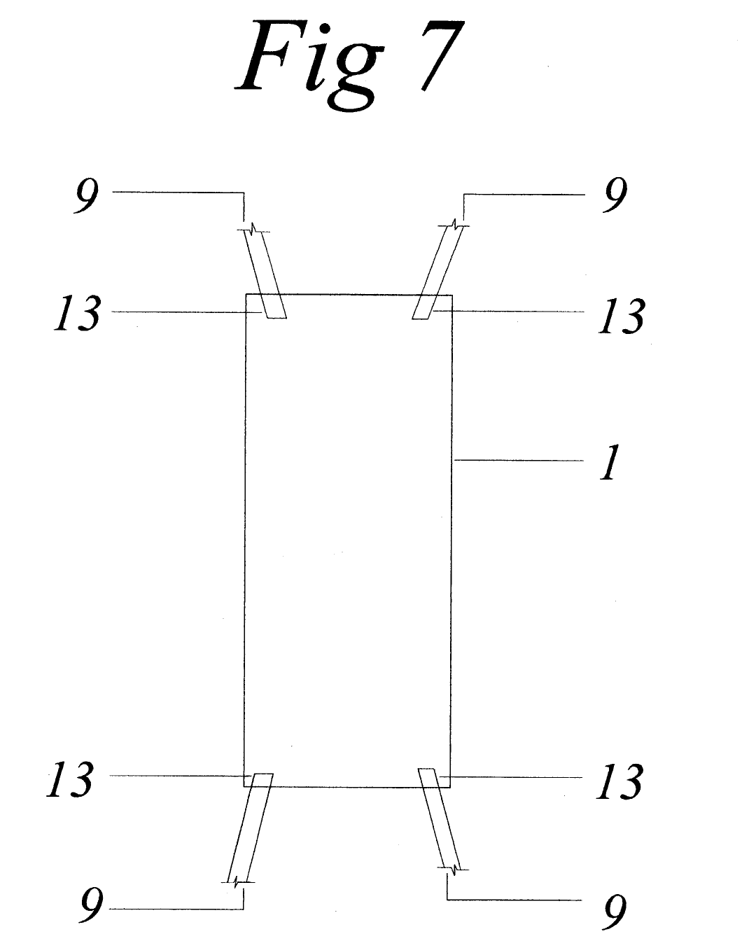

In the following diagrams of the invention, FIG. 1 is a front elevation. FIG. 2 is a large view of the main body panel. FIG. 3 is a large view of the end caps. FIG. 4 is an enlarged view of a centre grommet and elastic cord with an adjusting clip. FIG. 5 is an enlarged view of one main body grommet with a terminated elastic cord. FIG. 6 is an alternative method of constructing end caps along with a different elastic cording and adjusting clips. FIG. 7 is an alternative method of attaching the main body to the end caps.

The accident marking system illustrated is highly visible and fully adjustable to accommodate any snowboard. The majority of the system is made of a brightly coloured cloth and has three main components. The first being the “main body” (1) and the two “end caps” (4). The “end caps” are half circles stitched along the arch and open at the diameter. This forms a pocket in which the tip and tail rest. These three parts are connected using an elastic cording (7). One utilizes the system by applying an “end cap” onto the tip or tail and stretching the unit until the other “end cap” can be fitted onto the remaining tip or tail. The snowboard acts as the main support and gives the apparatus the optimal viewing angle. To tighten the marking system one pulls the cord (7) through the grommet (5) and brings the retaining clip (8) to the surface of the centre grommet (5).

In FIG. 2, the “main body” (1) is a large hemmed piece of materia. Reflective banding (3) is applied to the centre of the “main body” (1) and four grommets (2) are applied to the corners. The cord (7) is terminated at the four grommets (2) but runs through grommets (6) and (5). (Please refer to FIG. 3.) After the cord (7) meets at the grommet (5), it is pulled through and a retaining clip is applied (8). The retaining clip facilitates the adjusting of the marking system and holds the cord taught.

In FIG. 3, the two “end caps” (4) are large stitched pockets where the tip and tail are inserted. They have a piece of reflective banding (3) applied near the diameter or the opening. The elastic cording (7) runs freely through grommets (6) and (5).

FIG. 4 is an expanded view of the grommet (5). At the grommet (5), the ends of the cord come through and a retaining clip (8) is applied. The clip (8) allows one to contract and expand the overall system. Number (9) in FIGS. 4, 5, 6 and 7 represents the continuation of the elastic cording (7).

FIG. 5 is an enlarged view of the grommets (2) on the “main body”. The cord (7) is terminated at the grommet (2).

FIGS. 6 and 7 are an alternative method for attaching the “end caps” (4) to the “main body” (1). The same method for applying the system remains but the cording (10) and retaining clips (12) are different. The elastic cording (10) is a stretchy band which threads through a reinforced opening (11) near the opening and sides of the “end caps”. The cord (10) is then attached to a sliding retaining clip (12) to allow one to adjust the size of the accident marking system. In FIG. 7, the banding or cording (13) is stitched onto the corners of the “main body” (1) after the clips have been applied. The “main body” (1) in this case, is made of a solid reflective material with the possibility of applied lettering. Otherwise, all construction and application methods remain the same.

The foregoing are descriptions of the same preferred embodiments of the invention and do not limit the manner in which the objects of the invention can be accomplished.

The embodiments of the invention in which an exclusive property or privilege is claimed are defined as follows:

1) This invention relates to a portable marking system for use in conjunction with a snowboard, skis or other rigid apparatus comprising: (a) at least one positioning means to be attached to an extremity of the apparatus, (b) a main attention attracting body attached to said positioning means, (c) a second means for securing said main body to a portion of the rigid apparatus remote from said first extremity.

2) A system as defined in claim 1, where said rigid apparatus is a snowboard.

3) A system as defined in claim 1, where said second means for securing is a second positioning means.

4) A system as defined in claim 1, where the main body is made of fabric.

5) A system as defined in claim 4, where the main body is elastic.

6) A system as defined in claim 1, where the positioning means is a pocket or sleeve to attach to the top and bottom of said snowboard.

7) A system as defined in claim 1, where a means to adjust the tautness of the main body is present.
